(19) United States
(12) Patent Application Publication
(10) Pub. No.: US 2021/0162743 A1
(43) Pub. Date: Jun. 3, 2021

(54) LIQUID EJECTING APPARATUS AND DRIVE CIRCUIT

(71) Applicant: Seiko Epson Corporation, Tokyo (JP)

(72) Inventor: Sukehiro ITO, Matsumoto (JP)

(21) Appl. No.: 17/104,087

(22) Filed: Nov. 25, 2020

(30) Foreign Application Priority Data
Nov. 28, 2019 (JP) 2019-215084

(51) Int. Cl. B41J 2/045

(52) U.S. Cl. CPC B41J 2/04541; B41J 2/04508; B41J 2/04581; B41J 2/04573; B41J 2/0455

(57) ABSTRACT

A liquid ejecting apparatus includes a drive circuit that outputs a drive signal, in which the drive circuit includes an amplifier circuit that outputs an amplified modulation signal, and the amplifier circuit includes a first driver circuit electrically coupled to a first node to which a first voltage is supplied, a second driver circuit electrically coupled to a second node to which a second voltage is supplied, a first transistor electrically coupled to an output point from which the amplified modulation signal is output, a second transistor electrically coupled to the output point, a power supply node to which a third voltage is supplied, a capacitor electrically coupled to the output point and the first node, a first diode electrically coupled to the power supply node and the first node, and a step-down circuit electrically coupled to the power supply node and the second node.

The present application is based on, and claims priority from JP Application Serial Number 2019-215084, filed Nov. 28, 2019, the disclosure of which is hereby incorporated by reference herein in its entirety.

### BACKGROUND

### 1. Technical Field

The present disclosure relates to a liquid ejecting apparatus and a drive circuit.

### 2. Related Art

There is known a liquid ejecting apparatus that includes a piezoelectric element such as a piezo element to print an image or a document on a medium by ejecting the ink as a liquid. The piezoelectric element is provided corresponding to each of the plurality of nozzles that ejects the ink onto the medium. When each piezoelectric element is driven according to the drive signal, a predetermined amount of ink is ejected from the corresponding nozzle at a predetermined timing, and the ejected ink lands on the medium, so that a dot is formed at a desired position on the medium.

Such a piezoelectric element is electrically a capacitive load, such as a capacitor, and therefore, it is necessary to supply a sufficient current to a plurality of piezoelectric elements to drive the piezoelectric elements corresponding to a plurality of nozzles. Therefore, in order to supply a sufficient current to the piezoelectric elements, the liquid ejecting apparatus includes a drive signal output circuit that includes an amplifier circuit that amplifies the supplied original signal to output it as a drive signal. The amplifier circuit included in such a drive signal output circuit, for example, may include a class A amplifier circuit, a class B amplifier circuit, a class AB amplifier circuit, or the like, but from the viewpoint of power consumption reduction, in some cases, a class D amplifier circuit that is superior in energy conversion efficiency to the class A amplifier circuit, the class B amplifier circuit, and the class AB amplifier circuit is used.

JP-A-2016-097614 discloses that a liquid ejecting apparatus that includes a drive circuit, and that ejects a liquid by driving a piezoelectric element where the drive circuit includes a class D amplifier circuit, and outputs a drive signal that drives the piezoelectric element.

However, in the drive circuit disclosed in JP-A-2016-097614, the potential difference between the gate and source of the high-side transistor when the class D amplifier circuit is operating, and the potential difference between the gate and source of the low-side transistor are different. For this reason, the driving capability of the high-side transistor and that of the low-side transistor may be different from each other, and as a result, there is a possibility that the accuracy of the drive signal output from the drive circuit may deteriorate, and the accuracy of ejecting the liquid may deteriorate.

### SUMMARY

According to an aspect of the present disclosure, a liquid ejecting apparatus includes an ejection head having a drive element, the drive element driving by being supplied with a drive signal, where the ejection head ejects a liquid by driving of the drive element, and a drive circuit that outputs the drive signal, in which the drive circuit includes a modulation circuit that modulates a base drive signal that serves as a base of the drive signal and outputs a modulation signal, an amplifier circuit that amplifies the modulation signal and outputs an amplified modulation signal, and a demodulation circuit that demodulates the amplified modulation signal and outputs the drive signal, and the amplifier circuit includes a first driver circuit electrically coupled to a first node to which a first voltage is supplied, where the first driver circuit outputs a first control signal based on the first voltage and the modulation signal, a second driver circuit electrically coupled to a second node to which a second voltage is supplied, where the second driver circuit outputs a second control signal based on the second voltage and the modulation signal, a first transistor electrically coupled to an output point from which the amplified modulation signal is output, where the first transistor operates based on the first control signal, a second transistor electrically coupled to the output point, where the second transistor operates based on the second control signal, a power supply node to which a third voltage having a voltage value different from a voltage value of the first voltage and a voltage value of the second voltage is supplied, a capacitor whose one end is electrically coupled to the output point and whose other end is electrically coupled to the first node, a first diode whose anode is electrically coupled to the power supply node and whose cathode is electrically coupled to the first node, and a step-down circuit whose one end is electrically coupled to the power supply node and whose other end is electrically coupled to the second node.

According to an aspect of the present disclosure, in the liquid ejecting apparatus, the step-down circuit may include a second diode whose anode is electrically coupled to the power supply node and whose cathode is electrically coupled to the second node.

According to an aspect of the present disclosure, in the liquid ejecting apparatus, a forward voltage of the first diode may be substantially equal to a forward voltage of the second diode.

According to an aspect of the present disclosure, in the liquid ejecting apparatus, a shortest distance between the first driver circuit and the capacitor may be shorter than a shortest distance between the first driver circuit and the first diode.

According to an aspect of the present disclosure, in a drive circuit that outputs a drive signal that drives a drive element, the drive circuit includes a modulation circuit that modulates a base drive signal that serves as a base of the drive signal and outputs a modulation signal, an amplifier circuit that amplifies the modulation signal and outputs an amplified modulation signal, and a demodulation circuit that demodulates the amplified modulation signal and outputs the drive signal, in which the amplifier circuit includes a first driver circuit electrically coupled to a first node to which a first voltage is supplied, where the first driver circuit outputs a first control signal based on the first voltage and the modulation signal, a second driver circuit electrically coupled to a second node to which a second voltage is supplied, where the second driver circuit outputs a second control signal based on the second voltage and the modulation signal, a first transistor electrically coupled to an output point from which the amplified modulation signal is output, where the first transistor operates based on the first control signal, a second transistor electrically coupled to the output point, where the second transistor operates based on the second control signal, a power supply node to which a third voltage having a voltage value different from a voltage value of the first voltage and a voltage value of the second voltage is supplied, a capacitor whose one end is electrically coupled to the output point and whose other end is electrically coupled to the first node, a first diode whose anode is electrically coupled to the power supply node and whose cathode is electrically coupled to the first node, and a step-down circuit whose one end is electrically coupled to the power supply node and whose other end is electrically coupled to the second node.

### BRIEF DESCRIPTION OF THE DRAWINGS

FIG. 1 is a diagram illustrating a schematic configuration of the inside of a liquid ejecting apparatus.

FIG. 2 is a diagram illustrating an electrical configuration of the liquid ejecting apparatus.

FIG. 3 is a diagram illustrating a schematic configuration of one of ejection units.

FIG. 4 is a diagram illustrating an example of waveforms of drive signals COMA and COMB.

FIG. 5 is a diagram illustrating an example of waveforms of a drive signal VOUT.

FIG. 6 is a diagram illustrating a configuration of a selection control circuit and a selection circuit.

FIG. 7 is a diagram illustrating the decoding contents in a decoder.

FIG. 8 is a diagram illustrating a configuration of the selection circuit.

FIG. 9 is a diagram for explaining an operation of the selection control circuit and the selection circuit.

FIG. 10 is a diagram illustrating a circuit configuration of a drive signal output circuit.

FIG. 11 is a diagram illustrating waveforms of a voltage signal As and a modulation signal Ms in association with a waveform of an analog base drive signal aA.

FIG. 12 is a diagram for explaining an operation of an amplifier circuit.

FIG. 13 is a diagram illustrating a configuration of a drive signal output circuit in a second embodiment.

### DESCRIPTION OF EXEMPLARY EMBODIMENTS

Hereinafter, preferred embodiments of the present disclosure will be described with reference to the drawings. The drawings used are for convenience of explanation. The embodiments described below do not unduly limit the details of the present disclosure described in the claims. In addition, all of the configurations described below are not necessarily essential components of the disclosure.

### 1. First Embodiment

### 1.1 Configuration of Liquid Ejecting Apparatus

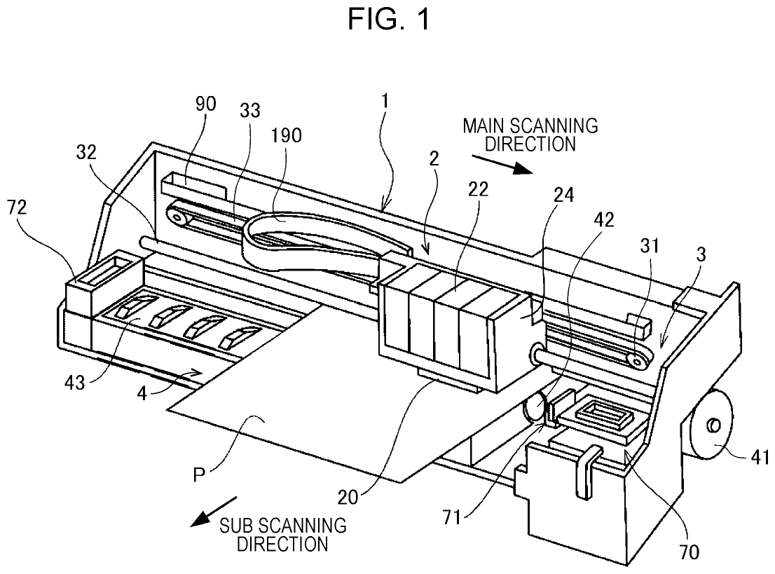

FIG. 1 is a diagram illustrating a schematic configuration of the inside of a liquid ejecting apparatus 1 according to the first embodiment. The liquid ejecting apparatus 1 is an ink jet printer from which the ink as a liquid is ejected in accordance with image data supplied from a host computer provided outside to form dots on a medium P such as paper, thereby printing an image according to the supplied image data. In FIG. 1, some of the components of the liquid ejecting apparatus 1 such as a housing and a cover are not illustrated.

As illustrated in FIG. 1, the liquid ejecting apparatus 1 includes a movement mechanism 3 that moves a head unit 2 in the main scanning direction. The movement mechanism 3 includes a carriage motor 31 serving as the driving source of the head unit 2, a carriage guide shaft 32 having both ends fixed, a timing belt 33 extending substantially parallel to the carriage guide shaft 32 and driven by the carriage motor 31. The movement mechanism 3 includes a linear encoder 90 that detects the position of the head unit 2 in the main scanning direction.

A carriage 24 of the head unit 2 is configured so that a predetermined number of ink cartridges 22 can be mounted thereon. The carriage 24 is reciprocably supported by the carriage guide shaft 32 and is fixed to a portion of the timing belt 33. Accordingly, the carriage 24 of the head unit 2 is guided by the carriage guide shaft 32 and reciprocates when the carriage motor 31 causes the timing belt 33 to travel forward and backward. That is, the carriage motor 31 moves the carriage 24 in the main scanning direction. A print head 20 is attached to a portion, of the carriage 24, facing the medium P. As will be described later, the print head 20 includes a large number of nozzles, and ejects a predetermined amount of ink from each nozzle at a predetermined timing. Various control signals are supplied to the head unit 2 operating as described above via a flexible flat cable 190.

The liquid ejecting apparatus 1 includes a transport mechanism 4 that transports the medium P in the sub scanning direction. The transport mechanism 4 includes a platen 43 that supports the medium P, a transport motor 41 that is a driving source, and a transport roller 42 that is rotated by the transport motor 41 and transports the medium P in the sub scanning direction. In a state where the medium P is supported by the platen 43, the ink is ejected from the print head 20 onto the medium P in accordance with the timing at which the medium P is transported by the transport mechanism 4, and accordingly a desired image is formed on the surface of the medium P.

A home position serving as a base point of the head unit 2 is set in an end region within the movement range of the carriage 24 included in the head unit 2. A capping member 70 that seals the nozzle formation face of the print head 20 and a wiper member 71 that wipes the nozzle formation face are disposed at the home position. The liquid ejecting apparatus 1 forms an image on the surface of the medium P bidirectionally when the carriage 24 moves forward toward the end opposite the home position, and when the carriage 24 moves backward from the opposite end toward the home position.

A flushing box 72 that collects the ink ejected from the print head 20 during a flushing operation is provided at the end of the platen 43 in the main scanning direction, and at the end opposite the home position from which the carriage 24 moves. The flushing operation is an operation of forcibly ejecting the ink from each nozzle regardless of the image data in order to prevent the possibility that the proper amount of the ink will not be ejected due to the nozzle clogging because of thickening of the ink near the nozzle, the air bubbles mixed in the nozzle, and the like. Note that the flushing boxes 72 may be provided on each sides of the platen 43 in the main scanning direction.

### 1.2 Electrical Configuration of Liquid Ejecting Apparatus

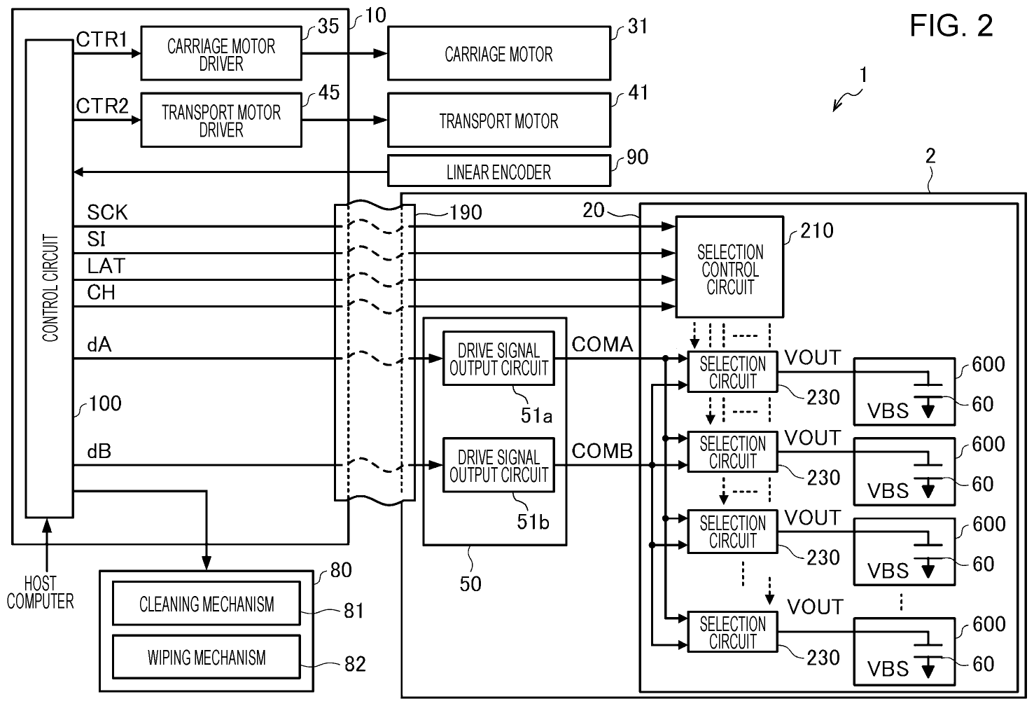

FIG. 2 is a diagram illustrating an electrical configuration of the liquid ejecting apparatus 1. As illustrated in FIG. 2, the liquid ejecting apparatus 1 includes a control unit 10 and the head unit 2. The control unit 10 and the head unit 2 are electrically coupled to each other via the flexible flat cable 190.

The control unit 10 includes a control circuit 100, a carriage motor driver 35, and a transport motor driver 45. The control circuit 100 generates a control signal corresponding to the image data supplied from the host computer to output the generated control signal to a corresponding configuration.

Specifically, the control circuit 100 grasps the current scanning position of the head unit 2 based on the detection signal of the linear encoder 90. The control circuit 100 generates control signals CTR1 and CTR2 corresponding to the current scanning position of the head unit 2. The control signal CTR1 is supplied to the carriage motor driver 35. The carriage motor driver 35 drives the carriage motor 31 in accordance with the input control signal CTR1. Further, the control signal CTR2 is supplied to the transport motor driver 45. The transport motor driver 45 drives the transport motor 41 in accordance with the input control signal CTR2. As a result, the movement of the carriage 24 in the main scanning direction and the transport of the medium P in the sub scanning direction are controlled.

In addition, the control circuit 100 generates, based on image data supplied from an externally provided host computer and a detection signal of the linear encoder 90, a clock signal SCK, a print data signal SI, a latch signal LAT, a change signal CH, and base drive signals dA and dB corresponding to the current scanning position of the head unit 2 to output the generated signals to head unit 2.

Further, the control circuit 100 causes a maintenance unit 80 to perform a maintenance process of restoring the ink ejection state of an ejection unit 600 to a normal state. The maintenance unit 80 includes a cleaning mechanism 81 and a wiping mechanism 82. The cleaning mechanism 81 performs, as a maintenance process, a pumping process of sucking the thickened ink, the air bubbles, and the like that are stored in the ejection unit 600 by a tube pump (not shown). Further, the wiping mechanism 82 performs, as a maintenance process, a wiping process of wiping foreign matter such as paper dust attached to the vicinity of the nozzle of the ejection unit 600 with the wiper member 71. The control circuit 100 may perform the above-described flushing operation as a maintenance process of restoring the ink ejection state of the ejection unit 600 to a normal state.

The head unit 2 includes a drive circuit 50 and the print head 20.

The drive circuit 50 includes drive signal output circuits 51a and 51b. The digital base drive signal dA is input to the drive signal output circuit 51a. The drive signal output circuit 51a generates a drive signal COMA by digital-to-analog converting the input base drive signal dA to class-D amplify the converted analog signal to output the generated drive signal COMA to the print head 20. Similarly, the digital base drive signal dB is input to the drive signal output circuit 51b. The drive signal output circuit 51b generates a drive signal COMB by digital-to-analog converting the input base drive signal dB to class-D amplify the converted analog signal to output the generated drive signal COMB to the print head 20.

That is, the base drive signal dA defines the waveform of the drive signal COMA, and the base drive signal dB defines the waveform of the drive signal COMB. Therefore, the base drive signals dA and dB may be signals that can define the waveforms of the drive signals COMA and COMB, and may be analog signals, for example. The details of the drive signal output circuits 51a and 51b will be described later. Further, in the description of FIG. 2, the drive circuit 50 is described as being included in the head unit 2, but the drive circuit 50 may be included in the control unit 10. In this case, the drive signals COMA and COMB output from the drive signal output circuits 51a and 51b, respectively, are supplied to the print head 20 via the flexible flat cable 190.

The print head 20 includes a selection control circuit 210, a plurality of selection circuits 230, and a plurality of ejection units 600 corresponding to the plurality of respective selection circuits 230. The selection control circuit 210 generates, based on the clock signal SCK, the print data signal SI, the latch signal LAT, and the change signal CH supplied from the control circuit 100, a selection signal for selecting or deselecting the waveforms of the drive signals COMA and COMB and outputs the generated selection signal to each of the plurality of selection circuits 230.

The drive signals COMA and COMB and the selection signal that is output from the selection control circuit 210 are input to each selection circuit 230. By selecting or deselecting the waveforms of the drive signals COMA and COMB based on the input selection signal, the selection circuit 230 generates a drive signal VOUT based on the drive signals COMA and COMB and outputs the generated drive signal VOUT to the corresponding ejection unit 600.

Each ejection unit 600 includes a piezoelectric element 60. The drive signal VOUT output from the corresponding selection circuit 230 is supplied to one end of the piezoelectric element 60. Further, a reference voltage signal VBS is supplied to the other end of the piezoelectric element 60. The piezoelectric element 60 included in the ejection unit 600 is driven according to a potential difference between the drive signal VOUT supplied to the one end and the reference voltage signal VBS supplied to the other end. An amount of ink corresponding to the driving of the piezoelectric element 60 is ejected from the ejection unit 600.

As described above, the liquid ejecting apparatus 1 according to the present embodiment includes the drive circuit 50 that outputs the drive signals COMA and COMB, and the print head 20 that includes the piezoelectric element 60 driven when the drive signal VOUT based on the drive signals COMA and COMB is supplied to the piezoelectric element 60, and that ejects the ink by driving the piezoelectric element 60. Here, the piezoelectric element 60 is an example of a drive element, and the drive signal VOUT that drives the piezoelectric element 60 and the drive signals COMA and COMB that serve as the base of the drive signal VOUT are an example of a drive signal. The print head 20 that ejects the ink by driving the piezoelectric element 60 is an example of an ejection head.

### 1.3 Configuration of Ejection Unit

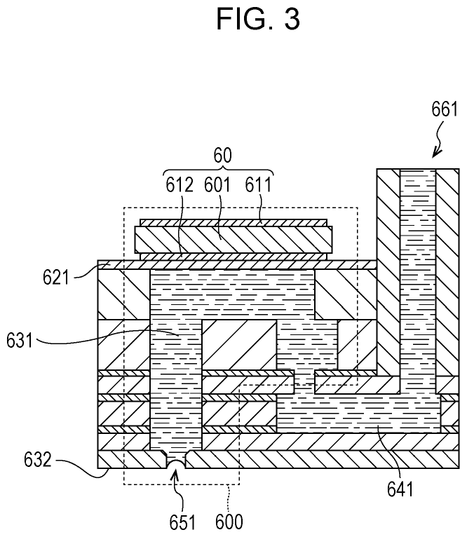

FIG. 3 is a diagram illustrating a schematic configuration of one of the plurality of ejection units 600 included in the print head 20. As illustrated in FIG. 3, the ejection unit 600 includes the piezoelectric element 60, a vibration plate 621, a cavity 631, and a nozzle 651.

The cavity 631 is filled with the ink supplied from a reservoir 641. Further, the ink is introduced into the reservoir 641 from the ink cartridge 22 via an ink tube (not shown) and a supply port 661. That is, the cavity 631 is filled with the ink stored in the corresponding ink cartridge 22.

The vibration plate 621 is displaced by driving the piezoelectric element 60 provided on the upper face in FIG. 3. With the displacement of the vibration plate 621, the internal volume of the cavity 631 filled with the ink expands or contracts. That is, the vibration plate 621 functions as a diaphragm that changes the internal volume of the cavity 631.

The nozzle 651 is an opening provided in a nozzle plate 632 and communicating with the cavity 631. When the internal volume of the cavity 631 changes, an amount of the ink corresponding to the change in the internal volume is ejected from the nozzle 651.

The piezoelectric element 60 has a structure in which a piezoelectric body 601 is sandwiched between a pair of electrodes 611 and 612. In the piezoelectric body 601 having such a structure, the central portion of the electrodes 611 and 612 bends in the vertical direction together with the vibration plate 621 in accordance with the potential difference between the voltages applied by the electrodes 611 and 612. Specifically, the drive signal VOUT is supplied to the electrode 611 of the piezoelectric element 60. Further, the reference voltage signal VBS is supplied to the electrode 612 of the piezoelectric element 60. The piezoelectric element 60 bends upward when the voltage level of the drive signal VOUT increases, and bends downward when the voltage level of the drive signal VOUT decreases.

In the ejection unit 600 configured as described above, the vibration plate 621 is displaced by the piezoelectric element 60 bending upward to increase the internal volume of the cavity 631. As a result, the ink is drawn from the reservoir 641. On the other hand, when the piezoelectric element 60 bends downward, the vibration plate 621 is displaced to reduce the internal volume of the cavity 631. As a result, an amount of the ink corresponding to the degree of reduction is ejected from the nozzle 651.

As described above, the piezoelectric element 60 is driven based on the electrode 611 supplied with the drive signal VOUT and the electrode 612 supplied with the reference voltage signal VBS. The piezoelectric element 60 is not limited to the structure illustrated in FIG. 3, but may have any structure as long as it can eject the ink from the ejection unit 600. Therefore, the piezoelectric element 60 is not limited to the above-described configuration of the bending vibration, but may be, for example, a configuration using the longitudinal vibration.

### 1.4 Configuration and Operation of Print Head

Next, the configuration and operation of the print head 20 will be described. As described above, the print head 20 generates the drive signal VOUT by selecting or deselecting the drive signals COMA and COMB output from the drive circuit 50 based on the clock signal SCK, the print data signal SI, the latch signal LAT, and the change signal CH to supply the generated drive signal VOUT to the corresponding ejection unit 600. Therefore, in describing the configuration and operation of the print head 20, first, an example of the waveforms of the drive signals COMA and COMB and an example of the waveform of the drive signal VOUT will be described.

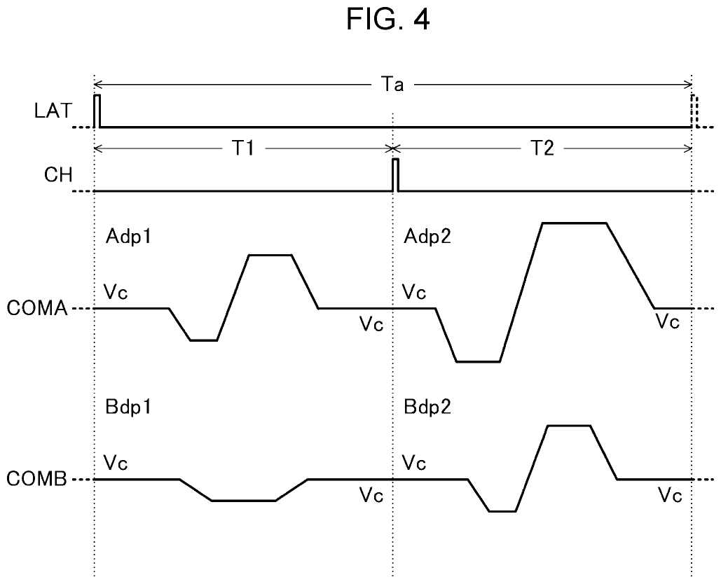

FIG. 4 is a diagram illustrating an example of the waveforms of the drive signals COMA and COMB. As illustrated in FIG. 4, the drive signal COMA includes a waveform in which a trapezoidal waveform Adp1 disposed in a period T1 from the rise of the latch signal LAT to the rise of the change signal CH, and a trapezoidal waveform Adp2 disposed in a period T2 from the rise of the change signal CH to the rise of the latch signal LAT are continuous. The trapezoidal waveform Adp1 is a waveform for ejecting a small amount of the ink from the nozzle 651, and the trapezoidal waveform Adp2 is a waveform for ejecting a medium amount of the ink that is larger than the small amount of the ink from the nozzle 651.

Further, the drive signal COMB includes a waveform in which a trapezoidal waveform Bdp1 disposed in the period T1 and a trapezoidal waveform Bdp2 disposed in the period T2 are continuous. The trapezoidal waveform Bdp1 is a waveform for not ejecting the ink from the nozzle 651, and is a waveform for preventing an increase in the ink viscosity by vibrating the ink near the opening of the nozzle 651. Further, as in the trapezoidal waveform Adp1, the trapezoidal waveform Bdp2 is a waveform for ejecting a small amount of the ink from the nozzles 651.

The voltages at the start timing and the end timing of each of the trapezoidal waveforms Adp1, Adp2, Bdp1, and Bdp2 are commonly a voltage Vc. That is, each of the trapezoidal waveforms Adp1, Adp2, Bdp1, and Bdp2 is a waveform that starts at the voltage Vc and ends at the voltage Vc. A cycle Ta including the period T1 and the period T2 corresponds to a printing cycle in which a new dot is formed on the medium P.

Here, in FIG. 4, the trapezoidal waveform Adp1 and the trapezoidal waveform Bdp2 are identical, but the trapezoidal waveform Adp1 and the trapezoidal waveform Bdp2 may be different from each other. Further, the description is made assuming that a small amount of the ink is ejected from the corresponding nozzle when the trapezoidal waveform Adp1 is supplied to the ejection unit 600, and when the trapezoidal waveform Bdp1 is supplied to the ejection unit 600, but different amounts of the ink may be ejected. That is, the waveforms of the drive signals COMA and COMB are not limited to the waveforms illustrated in FIG. 4, but various waveforms may be combined depending on the moving speed of the carriage 24 to which the print head 20 is attached, the properties of the ink stored in the ink cartridge 22, the material of the medium P, and the like.

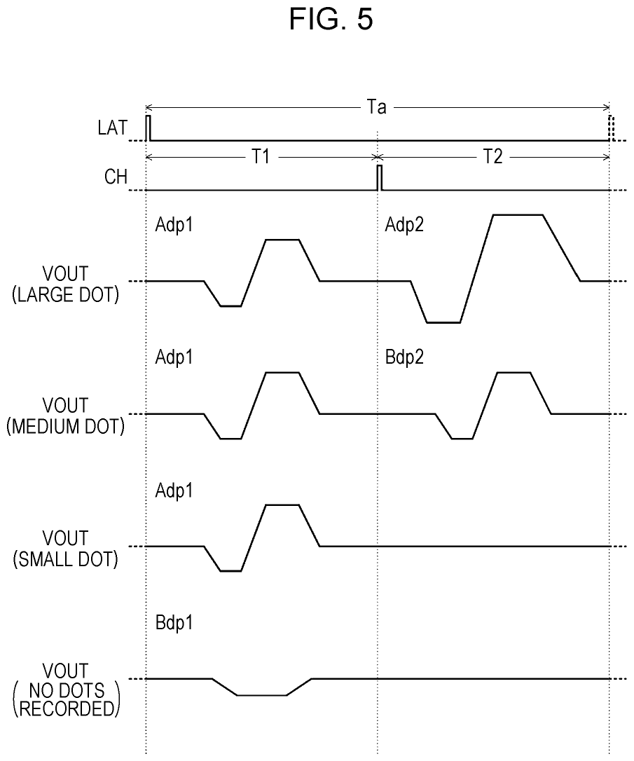

FIG. 5 is a diagram illustrating an example of the waveform of the drive signal VOUT. FIG. 5 illustrates the waveforms of the drive signal VOUT with the dots formed on the medium P having the sizes of the “large dot”, the “medium dot”, and the “small dot”, and having “no dots recorded” in comparison.

As illustrated in FIG. 5, the drive signal VOUT when the “large dot” is formed on the medium P represents a waveform in the cycle Ta in which the trapezoidal waveform Adp1 disposed in the period T1, and the trapezoidal waveform Adp2 disposed in the period T2 are continuous. When the drive signal VOUT is supplied to the ejection unit 600, a small amount of the ink and a medium amount of the ink are ejected from the corresponding nozzle 651 in the cycle Ta. Therefore, the large dot is formed on the medium P by landing and uniting the respective amounts of the ink.

The drive signal VOUT when the “medium dot” is formed on the medium P represents a waveform in the cycle Ta in which the trapezoidal waveform Adp1 disposed in the period T1, and the trapezoidal waveform Bdp2 disposed in the period T2 are continuous. When the drive signal VOUT is supplied to the ejection unit 600, a small amount of the ink is ejected twice from the corresponding nozzle 651 in the cycle Ta. Therefore, the medium dot is formed on the medium P by landing and uniting the respective amounts of the ink.

The drive signal VOUT when the “small dot” is formed on the medium P represents a waveform in the cycle Ta in which the trapezoidal waveform Adp1 disposed in the period T1, and a constant waveform, with the voltage Vc, disposed in the period T2 are continuous. When the drive signal VOUT is supplied to the ejection unit 600, a small amount of the ink is ejected from the corresponding nozzle 651 in the cycle Ta. Therefore, this amount of the ink lands on the medium P to form the small dot.

The drive signal VOUT corresponding to the “no dots recorded” in which no dots are formed on the medium P represents a waveform in the cycle Ta in which the trapezoidal waveform Bdp1 disposed in the period T1, and a constant waveform, with the voltage Vc, disposed in the period T2 are continuous. When the drive signal VOUT is supplied to the ejection unit 600, the ink near the opening of the corresponding nozzle 651 only slightly vibrates, and no ink is ejected in the cycle Ta. Therefore, the ink does not land on the medium P and no dots are formed.

Here, the waveform that is constant at the voltage Vc is a waveform with a voltage of the immediately preceding voltage Vc being held in the piezoelectric element 60, which is a capacitive load, when none of the trapezoidal waveforms Adp1, Adp2, Bdp1, and Bdp2 is selected as the drive signal VOUT. Therefore, when none of the trapezoidal waveforms Adp1, Adp2, Bdp1, and Bdp2 is selected as the drive signal VOUT, it can be said that the voltage Vc is supplied to the ejection unit 600 as the drive signal VOUT.

The drive signal VOUT as described above is generated when the waveforms of the drive signals COMA and COMB are selected or deselected by the operation of the selection control circuit 210 and the selection circuit 230.

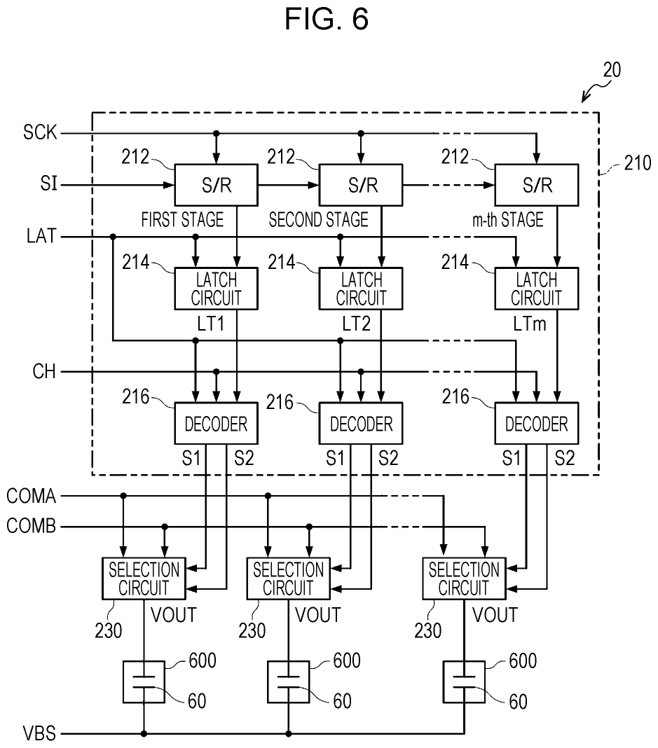

FIG. 6 is a diagram illustrating configurations of the selection control circuit 210 and the selection circuits 230. As illustrated in FIG. 6, the print data signal SI, the latch signal LAT, the change signal CH, and the clock signal SCK are input to the selection control circuit 210. The selection control circuit 210 includes a set of a shift register (S/R) 212, a latch circuit 214, and a decoder 216 corresponding to each of the m ejection units 600. That is, the selection control circuit 210 includes the same number of sets of the shift registers 212, the latch circuits 214, and the decoders 216 as the m ejection units 600.

The print data signal SI is a signal synchronized with the clock signal SCK, and is a total 2·m-bit signal including 2-bit print data [SIH, SIL] for selecting any one of the “large dot”, the “medium dot”, the “small dot”, and the “no dots recorded” for each of the m ejection units 600. The input print data signal SI is held in the shift register 212 for 2-bit print data [SIH, SIL] included in the print data signal SI corresponding to each of the m ejection units 600. Specifically, the selection control circuit 210 is configured such that the m-stage shift registers 212 corresponding to the m ejection units 600 are cascade-coupled to each other, and the print data signal SI input serially is sequentially transferred to the subsequent stage in accordance with the clock signal SCK. In FIG. 6, in order to distinguish the shift registers 212, they are denoted as the first stage, the second stage . . . , and the m-th stage in order from the upstream shift register to which the print data signal SI is input.

Each of the m latch circuits 214 latches the 2-bit print data [SIH, SIL] held by the respective m shift registers 212 at the rising edge of the latch signal LAT.

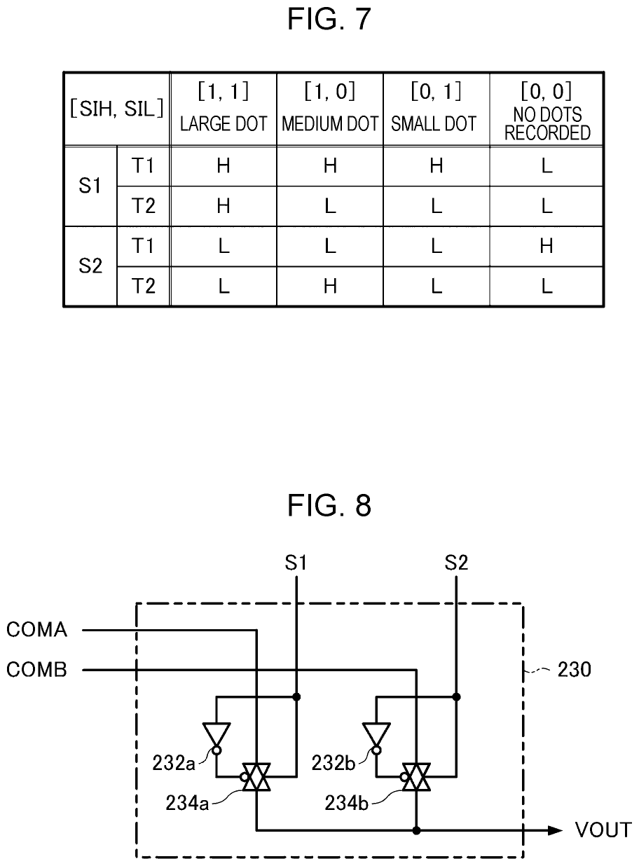

FIG. 7 is a diagram illustrating the decoding contents in the decoder 216. The decoder 216 outputs selection signals S1 and S2 in accordance with the 2-bit print data [SIH, SIL] latched by the latch circuit 214. For example, when the 2-bit print data [SIH, SIL] is [1, 0], the decoder 216 outputs the selection signal S1 with the logic level of H and L levels in the periods T1 and T2, respectively, and the selection signal S2 with the logic level of L and H levels in the periods T1 and T2, respectively, to the selection circuit 230.

The selection circuit 230 is provided corresponding to each of the ejection units 600. That is, the number of the selection circuits 230 included in the print head 20 is m, which is the same as the total number of the ejection units 600. FIG. 8 is a diagram illustrating a configuration of the selection circuit 230 corresponding to the one ejection unit 600. As illustrated in FIG. 8, the selection circuit 230 includes inverters 232a and 232b, which are NOT circuits, and transfer gates 234a and 234b.

The selection signal S1 is input to the non-circled positive control terminal in the transfer gate 234a, while being input to the circled negative control terminal in the transfer gate 234a after logically inverted by the inverter 232a. The drive signal COMA is supplied to the input terminal of the transfer gate 234a. The selection signal S2 is input to the non-circled positive control terminal in the transfer gate 234b, while being input to the circled negative control terminal in the transfer gate 234b after logically inverted by the inverter 232b. The drive signal COMB is supplied to the input terminal of the transfer gate 234b. The output terminals of the transfer gates 234a and 234b are coupled in common and the drive signal VOUT is output.

Specifically, when the selection signal S1 is at H level, the transfer gate 234a is brought into a conductive state between the input terminal and the output terminal, and when the selection signal S1 is at L level, the transfer gate 234a is brought into a non-conductive state between the input terminal and the output terminal. When the selection signal S2 is at H level, the transfer gate 234b is brought into a conductive state between the input terminal and the output terminal, and when the selection signal S2 is at L level, the transfer gate 234b is brought into a non-conductive state between the input terminal and the output terminal. As described above, the selection circuit 230 generates and outputs the drive signal VOUT by selecting the waveforms of the drive signals COMA and COMB based on the selection signals S1 and S2.

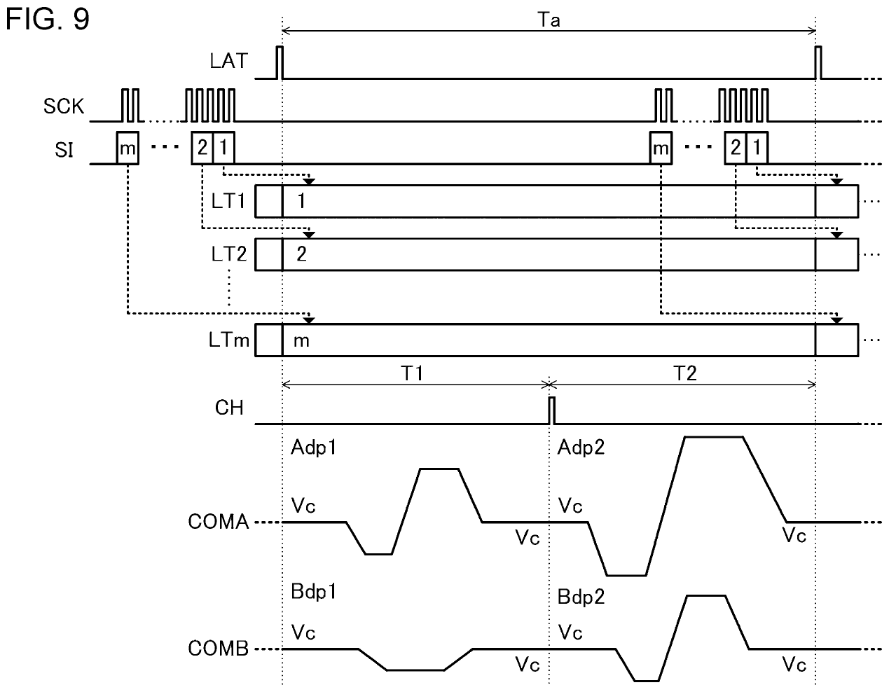

Here, operations of the selection control circuit 210 and the selection circuit 230 will be described with reference to FIG. 9. FIG. 9 is a diagram for explaining the operations of the selection control circuit 210 and the selection circuit 230. The print data signal SI is serially input in synchronization with the clock signal SCK, and is sequentially transferred to the shift registers 212 corresponding to the respective ejection units 600. When the input of the clock signal SCK stops, each shift register 212 holds 2-bit print data [SIH, SIL] corresponding to each of the ejection units 600. The print data signal SI is input to the shift registers 212 of the m-th stage . . . the second stage, and the first-stage in the order of the corresponding ejection units 600.

When the latch signal LAT rises, each of the latch circuits 214 simultaneously latches the 2-bit print data [SIH, SIL] held in the respective shift registers 212. In FIG. 9, LT1, LT2 . . . , and LTm indicate 2-bit print data [SIH, SIL] latched by the latch circuits 214 corresponding to the shift registers 212 of the first stage, the second stage . . . , and the m-th stage, respectively.

The decoder 216 outputs the selection signals S1 and S2 with the logic levels according to the contents as illustrated in FIG. 7 in each of the periods T1 and T2 in accordance with a dot size defined by the latched 2-bit print data [SIH, SIL].

Specifically, when the print data [SIH, SIL] is [1, 1], the decoder 216 sets the selection signal S1 to H and H levels in the periods T1 and T2, respectively, and sets the selection signal S2 to L and L levels in the periods T1 and T2, respectively. In this case, the selection circuit 230 selects the trapezoidal waveform Adp1 in the period T1, and selects the trapezoidal waveform Adp2 in the period T2. As a result, the drive signal VOUT corresponding to the “large dot” illustrated in FIG. 5 is generated.

Also, when the print data [SIH, SIL] is [1, 0], the decoder 216 sets the selection signal S1 to H and L levels in the periods T1 and T2, respectively, and sets the selection signal S2 to L and H levels in the periods T1 and T2, respectively. In this case, the selection circuit 230 selects the trapezoidal waveform Adp1 in the period T1, and selects the trapezoidal waveform Bdp2 in the period T2. As a result, the drive signal VOUT corresponding to the “medium dot” illustrated in FIG. 5 is generated.

Further, when the print data [SIH, SIL] is [0, 1], the decoder 216 sets the selection signal S1 to H and L levels in the periods T1 and T2, respectively, and sets the selection signal S2 to L and L levels in the periods T1 and T2, respectively. In this case, the selection circuit 230 selects the trapezoidal waveform Adp1 in the period T1, and selects none of the trapezoidal waveforms Adp2 and Bdp2 in the period T2. As a result, the drive signal VOUT corresponding to the “small dot” illustrated in FIG. 5 is generated.

Further, when the print data [SIH, SIL] is [0, 0], the decoder 216 sets the selection signal S1 to L and L levels in the periods T1 and T2, respectively, and sets the selection signal S2 to the H and L levels in the periods T1 and T2, respectively. In this case, the selection circuit 230 selects the trapezoidal waveform Bdp1 in the period T1, and selects none of the trapezoidal waveforms Adp2 and Bdp2 in the period T2. As a result, the drive signal VOUT corresponding to “no dots recorded” illustrated in FIG. 5 is generated.

As described above, the selection control circuit 210 and the selection circuit 230 select the waveforms of the drive signals COMA and COMB based on the print data signal SI, the latch signal LAT, the change signal CH, and the clock signal SCK to output the selected waveforms as the drive signal VOUT to the ejection unit 600. 1.5 Configuration of Drive Signal Output Circuit

Next, the configuration and operation of the drive signal output circuits 51a and 51b that output the drive signals COMA and COMB will be described. Here, the drive signal output circuit 51a and the drive signal output circuit 51b have the same configuration except that the input signal and the output signal are different from each other. Therefore, in the following description, only the configuration and operation of the drive signal output circuit 51a will be described, and the description of the configuration and operation of the drive signal output circuit 51b will be omitted.

The drive signal output circuit 51a first converts the base drive signal dA into an analog signal, and second, feeds back the output drive signal COMA, and corrects the deviation between the attenuation signal based on the drive signal COMA and the target signal by a high-frequency component of the drive signal COMA to generate a modulation signal in accordance with the corrected signal. Third, the drive signal output circuit 51a generates an amplified modulation signal by switching transistors M1 and M2 in accordance with the modulation signal, and fourth, demodulates the amplified modulation signal by smoothing the amplified modulation signal with a low-pass filter to output the demodulated signal as the drive signal COMA.

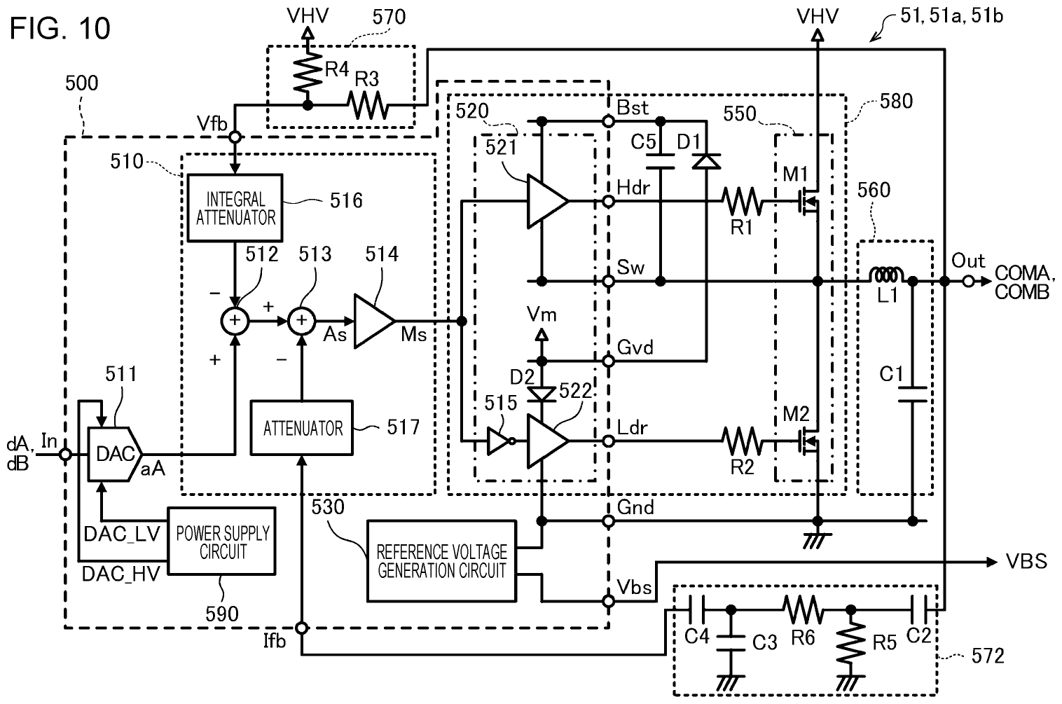

FIG. 10 is a diagram illustrating a circuit configuration of the drive signal output circuit 51a. As illustrated in FIG. 10, the drive signal output circuit 51a includes an integrated circuit 500, a switching circuit 550, a smoothing circuit 560, a first feedback circuit 570, a second feedback circuit 572, and other circuit elements.

The integrated circuit 500 is electrically coupled to the outside of the integrated circuit 500 through a plurality of terminals including a terminal In, a terminal Bst, a terminal Hdr, a terminal Sw, a terminal Gvd, a terminal Ldr, a terminal Gnd, and a terminal Vbs. Then, the integrated circuit 500 modulates the base drive signal dA input from the terminal In and drives each of the transistors M1 and M2 included in the switching circuit 550.

As illustrated in FIG. 10, the integrated circuit 500 includes a digital to analog converter (DAC) 511, a modulation circuit 510, a gate drive circuit 520, a reference voltage generation circuit 530, and a power supply circuit 590.

The power supply circuit 590 generates a first voltage signal DAC_HV and a second voltage signal DAC_LV to supply them to the DAC 511.

The DAC 511 converts the digital base drive signal dA that defines the waveform of the drive signal COMA into a base drive signal aA that is an analog signal having a voltage value between the first voltage signal DAC_HV and the second voltage signal DAC_LV to output the converted base drive signal aA to the modulation circuit 510. Note that the maximum value of the voltage amplitude of the base drive signal aA is defined by the first voltage signal DAC_HV, and the minimum value is defined by the second voltage signal DAC_LV. That is, the first voltage signal DAC_HV is a reference voltage of the DAC 511 on the high voltage side, and the second voltage signal DAC_LV is a reference voltage of the DAC 511 on the low voltage side. A signal obtained by amplifying the analog base drive signal aA is the drive signal COMA. That is, the base drive signal aA corresponds to a target signal before the amplification of the drive signal COMA. The voltage amplitude of the base drive signal aA in the present embodiment is, for example, 1 V to 2 V.

The modulation circuit 510 generates the modulation signal Ms obtained by modulating the base drive signal aA to output the generated modulation signal Ms to the switching circuit 550 via the gate drive circuit 520. Modulation circuit 510 includes adders 512 and 513, a comparator 514, an integral attenuator 516, and an attenuator 517.

The integral attenuator 516 attenuates and integrates the voltage of a terminal Out input via a terminal Vfb, that is, the drive signal COMA, and supplies the attenuated and integrated signal to a negative input terminal of the adder 512. The base drive signal aA is input to a positive input terminal of the adder 512. The adder 512 supplies, to the positive input terminal of the adder 513, a voltage obtained by subtracting the voltage input to the negative input terminal from the voltage input to the positive input terminal and integrating the difference.

Here, the maximum value of the voltage amplitude of the base drive signal aA is about 2 V as described above, whereas the maximum value of the voltage of the drive signal COMA may exceed 40 V in some cases. For this reason, the integral attenuator 516 attenuates the voltage of the drive signal COMA input via the terminal Vfb in order to match the amplitude ranges of both voltages when obtaining the deviation.

The attenuator 517 supplies a voltage obtained by attenuating the high-frequency component of the drive signal COMA input via a terminal Ifb to the negative input terminal of the adder 513. Further, the voltage output from the adder 512 is input to the positive input terminal of the adder 513. The adder 513 outputs to the comparator 514 a voltage signal As obtained by subtracting the voltage input to the negative input terminal from the voltage input to the positive input terminal.

The voltage signal As output from the adder 513 is a voltage obtained by subtracting the voltage of the signal supplied to the terminal Vfb and further subtracting the voltage of the signal supplied to the terminal Ifb from the voltage of the base drive signal aA. For this reason, the voltage of the voltage signal As output from the adder 513 is a signal obtained by correcting the deviation obtained by subtracting the attenuation voltage of the drive signal COMA from the target voltage of the base drive signal aA by the high-frequency component of the drive signal COMA.

The comparator 514 outputs the pulse-modulated modulation signal Ms based on the voltage signal As output from the adder 513. Specifically, the comparator 514 outputs the modulation signal Ms which is at H level when the voltage signal As output from the adder 513 is equal to or higher than a threshold Vth1 described later in a case where the voltage is rising, and is at L level when the voltage signal As falls below a threshold Vth2 described later in a case where the voltage is dropping. Here, the thresholds Vth1 and Vth2 are set in a relationship in which the threshold Vth1 is greater than the threshold Vth2. The frequency and the duty ratio of the modulation signal Ms change in accordance with the base drive signals dA and aA. Therefore, the attenuator 517 adjusts the modulation gain corresponding to the sensitivity, so that the change amount of the frequency or the duty ratio of the modulation signal Ms can be adjusted.

The modulation signal Ms output from the comparator 514 is supplied to a gate driver 521 included in the gate drive circuit 520. The modulation signal Ms is also supplied to a gate driver 522 included in the gate drive circuit 520 after the logic level is inverted by an inverter 515. That is, the logic levels of the signals supplied to the gate driver 521 and the gate driver 522 are mutually exclusive.

Here, the timing may be controlled so that the logic levels of the signals supplied to the gate driver 521 and the gate driver 522 are not H level at the same time. In other words, “exclusive” here means, strictly speaking, that the logic levels of the signals supplied to the gate driver 521 and the gate driver 522 are not H level at the same time. For details, this means that the transistor M1 and the transistor M2 included in the switching circuit 550 are not turned on at the same time.

The gate drive circuit 520 includes the gate drivers 521 and 522 and the inverter 515.

The gate driver 521 operates on the high-potential-side of the gate drive circuit 520. The high side power supply voltage of the gate driver 521 is a voltage supplied via the terminal Bst, and the low side power supply voltage is a voltage supplied via the terminal Sw. Then, the gate driver 521 outputs the first amplification control signal based on the input modulation signal Ms and the power supply voltage from the terminal Hdr.

Here, the terminal Bst to which the high-potential-side power supply voltage of the gate driver 521 is supplied is coupled to one end of a capacitor C5 and the cathode of a backflow prevention diode D1, and the terminal Sw to which the low-potential-side power supply voltage is supplied is coupled to the other end of the capacitor C5. The anode of the diode D1 is coupled to the terminal Gvd. That is, the high-potential-side power supply voltage of the gate driver 521 is supplied from a bootstrap circuit composed of the capacitor C5 and the diode D1.

The gate driver 522 operates on the low-potential-side of the gate drive circuit 520 and at a potential lower than that of the gate driver 521. The high side power supply voltage of the gate driver 521 is a voltage Vm supplied via a diode D2 and, the low side power supply voltage is a ground potential of, for example, 0 V supplied via the terminal Gnd. The gate driver 522 outputs, from the terminal Ldr, a second amplification control signal based on a signal obtained by inverting the logic level of the modulation signal Ms output from the comparator 514 by the inverter 515 and the power supply voltage. The details of the operation of the gate drive circuit 520 will be described later.

The reference voltage generation circuit 530 outputs the reference voltage signal VBS of a DC voltage of, for example, 6 V, which is supplied to the electrode 612 of the piezoelectric element 60. The reference voltage generation circuit 530 is configured by a constant voltage circuit including a band gap reference circuit, for example. The reference voltage signal VBS is a signal of a potential serving as a reference for driving the piezoelectric element 60, and may be, for example, a signal of a ground potential.

The switching circuit 550 includes the transistor M1 and the transistor M2. A voltage VHV, which is a DC voltage of, for example, 42 V is supplied to the drain terminal of the transistor M1. The gate terminal of the transistor M1 is electrically coupled to one end of a resistor R1, and the other end of the resistor R1 is electrically coupled to the terminal Hdr of the integrated circuit 500. That is, the first amplification control signal output from the terminal Hdr of the integrated circuit 500 is supplied to the gate of the transistor M1. The source of the transistor M1 is electrically coupled to the terminal Sw of the integrated circuit 500.

The drain of the transistor M2 is electrically coupled to the terminal Sw of the integrated circuit 500. That is, the drain of the transistor M2 and the source of the transistor M1 are electrically coupled to each other. The gate of the transistor M2 is electrically coupled to one end of a resistor R2, and the other end of the resistor R2 is electrically coupled to the terminal Ldr of the integrated circuit 500. That is, the second amplification control signal output from the terminal Ldr of the integrated circuit 500 is supplied to the gate of the transistor M2. The ground potential is supplied to the source of the transistor M2.

The switching circuit 550 configured as described above is exclusively driven based on the first amplification control signal and the second amplification control signal output from the gate drive circuit 520. As a result, an amplified modulation signal obtained by amplifying the modulation signal Ms based on the voltage VHV is generated at the coupling point where the drain of the transistor M2 and the source of the transistor M1 are coupled. The details of the operation of the switching circuit 550 will be described later.

The smoothing circuit 560 generates the drive signal COMA by smoothing the amplified modulation signal output from the switching circuit 550 to output the generated drive signal COMA from the drive signal output circuit 51a. The smoothing circuit 560 includes a coil L1 and a capacitor C1.

The amplified modulation signal output from the switching circuit 550 is input to one end of the coil L1. The other end of the coil L1 is coupled to the terminal Out serving as an output of the drive signal output circuit 51a. That is, the drive signal output circuit 51a is coupled to each of the selection circuits 230 via the terminal Out. As a result, the drive signal COMA output from the drive signal output circuit 51a is supplied to the selection circuit 230. The other end of the coil L1 is also coupled to one end of the capacitor C1. The ground potential is supplied to the other end of the capacitor C1. That is, the coil L1 and the capacitor C1 demodulate the amplified modulation signal by smooths the amplified modulation signal output from the switching circuit 550, and output the demodulation signal as the drive signal COMA.

The first feedback circuit 570 includes a resistor R3 and a resistor R4. One end of the resistor R3 is coupled to the terminal Out from which the drive signal COMA is output, and the other end is coupled to the terminal Vfb and one end of the resistor R4. The voltage VHV is supplied to the other end of the resistor R4. As a result, the drive signal COMA that has passed through the first feedback circuit 570 from the terminal Out is fed back to the terminal Vfb in a pulled-up state.

The second feedback circuit 572 includes capacitors C2, C3, and C4 and resistors R5 and R6. One end of the capacitor C2 is coupled to the terminal Out from which the drive signal COMA is output, and the other end is coupled to one end of the resistor R5 and one end of the resistor R6. The ground potential is supplied to the other end of the resistor R5. Thus, the capacitor C2 and the resistor R5 function as a high pass filter. The cut-off frequency of the high-pass filter is set to, for example, about 9 MHz. The other end of the resistor R6 is coupled to one end of the capacitor C4 and one end of the capacitor C3. The ground potential is supplied to the other end of the capacitor C3. Thus, the resistor R6 and the capacitor C3 function as a low pass filter. The cutoff frequency of the LPF is set to, for example, about 160 MHz. In this way, since the second feedback circuit 572 includes the high-pass filter and the low-pass filter, so that the second feedback circuit 572 functions as a band pass filter that passes the drive signal COMA in a predetermined frequency range.

The other end of the capacitor C4 is coupled to the terminal Ifb of the integrated circuit 500. As a result, a signal obtained by cutting the DC component out of the high frequency components of the drive signal COMA that has passed through the second feedback circuit 572 that functions as the band pass filter is fed back to the terminal Ifb.

The drive signal COMA output from the terminal Out is a signal obtained by smoothing the amplified modulation signal by the smoothing circuit 560. The drive signal COMA is integrated/subtracted via the terminal Vfb, and then fed back to the adder 512. Therefore, the drive signal output circuit 51a self-oscillates at a frequency determined by the feedback delay and the feedback transfer function.

However, since the feedback path via the terminal Vfb has a large delay amount, so that there is a case where the frequency of the self-oscillation cannot be made high enough to ensure the accuracy of the drive signal COMA simply by the feedback via the terminal Vfb. Therefore, the delay in the entire circuit is reduced by providing a path through which the high-frequency component of the drive signal COMA is fed back via the terminal Ifb separately from the path via the terminal Vfb. As a result, the frequency of the voltage signal As can be made high enough to ensure the accuracy of the drive signal COMA as compared with the case where there is no path via the terminal Ifb.

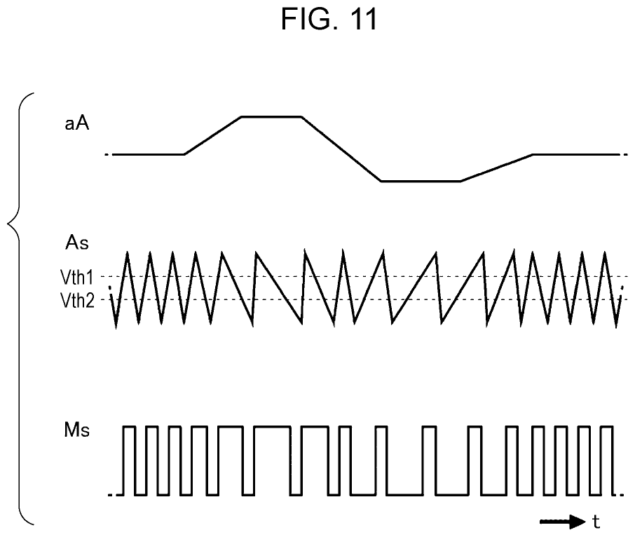

FIG. 11 is a diagram illustrating the waveforms of the voltage signal As and the modulation signal Ms in association with the waveform of the analog base drive signal aA.

As illustrated in FIG. 11, the voltage signal As is a triangular wave, and its oscillation frequency varies according to the voltage of the base drive signal aA. Specifically, the frequency is highest when the voltage of the base drive signal aA has an intermediate value, and decreases as the voltage of the base drive signal aA has a value higher or lower than the intermediate value.

Further, the slope of the triangular wave of the voltage signal As at the rise of the voltage is almost equal to that at the fall of the voltage when the voltage has the nearly intermediate value. Therefore, the duty ratio of the modulation signal Ms obtained by comparing the voltage signal As with the thresholds Vth1 and Vth2 of the comparator 514 is approximately 50%. When the voltage of the voltage signal As increases from the intermediate value, the downward slope of the voltage signal As is gentle. Therefore, the period during which the modulation signal Ms is at H level is relatively long, and the duty ratio of the modulation signal Ms increases. On the other hand, when the voltage of the voltage signal As decreases from the intermediate value, the upward slope of the voltage signal As decreases. Therefore, the period during which the modulation signal Ms is at H level is relatively short, and the duty ratio of the modulation signal Ms decreases.

The gate driver 521 turns on or off the transistor M1 based on the modulation signal Ms. That is, the gate driver 521 turns on the transistor M1 when the modulation signal Ms is at H level, and turns off the transistor M1 when the modulation signal Ms is at L level. The gate driver 522 turns on or off the transistor M2 based on the logically inverted signal of the modulation signal Ms. That is, the gate driver 522 turns off the transistor M2 when the modulation signal Ms is at H level and turns on the transistor M2 when the modulation signal Ms is at L level.

Therefore, the voltage value of the drive signal COMA obtained by smoothing the amplified modulation signal output from the switching circuit 550 by the smoothing circuit 560 increases as the duty ratio of the modulation signal Ms increases, and decreases as the duty ratio decreases. That is, the control is performed so that the waveform of the drive signal COMA matches the waveform obtained by enlarging the voltage of the base drive signal aA obtained by performing the analog conversion on the digital base drive signal dA.

Further, since the drive signal output circuit 51a uses the pulse density modulation, there is also an advantage that the change width of the duty ratio can be made large as compared with that of the pulse width modulation with a fixed modulation frequency. The minimum positive pulse width and the minimum negative pulse width that can be used in the drive signal output circuit 51a are limited by circuit characteristics. Therefore, in the pulse width modulation in which the frequency is fixed, the change width of the duty ratio is limited within a predetermined range. In contrast, with the pulse density modulation, as the voltage of the voltage signal As moves away from the intermediate value, the oscillation frequency decreases, and as a result, it is possible to further increase the duty ratio in a region where the voltage is high. Further, it is possible to further decrease the duty ratio in a region where the voltage is low. Therefore, it is possible to secure a wider range of the change width of the duty ratio by employing self-oscillation type pulse density modulation.

Here, in the drive signal output circuit 51a in the present embodiment, a configuration including the gate drive circuit 520 that generates the first amplification control signal and the second amplification control signal based on the modulation signal Ms, and the switching circuit 550 that outputs the amplified modulation signal by being driven based on the first amplification control signal and the second amplification control signal is referred to as an amplifier circuit 580. That is, the drive signal output circuit 51a in the present embodiment includes the modulation circuit 510 that modulates the base drive signal dA that serves as the base of the drive signal COMA, to output the modulation signal Ms, the amplifier circuit 580 that amplifies the modulation signal Ms to output the amplified modulation signal, and the smoothing circuit 560 that demodulates the amplified modulation signal to output the drive signal COMA. Here, the smoothing circuit 560 is an example of a demodulation circuit.

### 1.6 Operation of Amplifier Circuit

Here, the operation of the amplifier circuit 580 included in the drive signal output circuit 51a in the present embodiment will be described.

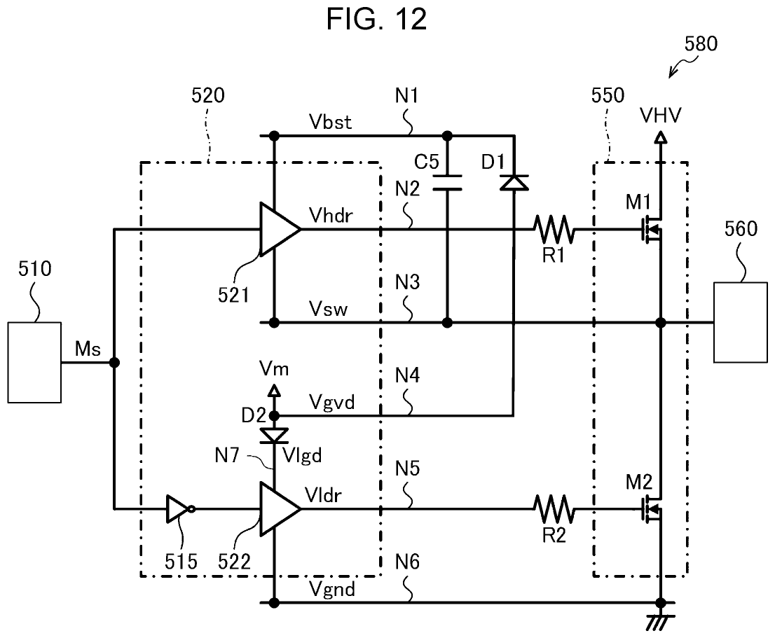

FIG. 12 is a diagram for explaining the operation of the amplifier circuit 580. In addition, in FIG. 12, a node N1 electrically coupled to the terminal Bst, a node N2 electrically coupled to the terminal Hdr, a node N3 electrically coupled to the terminal Sw, a node N4 electrically coupled to the terminal Gvd, a node N5 electrically coupled to the terminal Ldr, and a node N6 electrically coupled to the terminal Gnd are illustrated in place of the terminal that outputs a signal from the integrated circuit 500. An electrical coupling portion between the power supply terminal of the gate driver 522 included in the gate drive circuit 520 and the cathode of the diode D2 included in the gate drive circuit 520 is referred to as a node N7.

The voltage supplied to the node N1 is referred to as a voltage Vbst, the voltage supplied to the node N2 is referred to as a voltage Vhdr, the voltage supplied to the node N3 is referred to as a voltage Vsw, the voltage supplied to the node N4 is referred to as a voltage Vgvd, the voltage supplied to the node N5 is referred to as a voltage Vldr, the voltage supplied to the node N6 is referred to as a voltage Vgnd, and the voltage supplied to the node N7 is referred to as a voltage Vlgd. That is, the first amplification control signal output from the above-mentioned gate driver 521 corresponds to the voltage Vhdr, the second amplification control signal output from the gate driver 522 corresponds to the voltage Vldr, and the amplified modulation signal output from the switching circuit 550 corresponds to the voltage Vsw. The voltage Vgnd corresponds to the signal of the ground potential.

As illustrated in FIG. 12, the amplifier circuit 580 includes the gate drive circuit 520, the switching circuit 550, the capacitor C5, and the diode D1.

The gate drive circuit 520 includes the gate drivers 521 and 522, and the inverter 515.

The gate driver 521 electrically couples the node N1 supplied with the voltage Vbst and the node N3 supplied with the voltage Vsw, and generates the voltage Vhdr based on the voltage Vbst and the voltage Vsw, and the modulation signal Ms to output the generated voltage Vhdr to the node N2. Then, the voltage Vhdr is supplied to the gate of the transistor M1 included in the switching circuit 550 via the node N2. In other words, the gate driver 521 outputs the voltage Vhdr to the gate of the transistor M1 included in the switching circuit 550.

Specifically, when the modulation signal Ms input to the gate driver 521 is at H level, the gate driver 521 outputs, as the voltage Vhdr, the voltage Vbst which is the high-potential-side power supply voltage, and when the modulation signal Ms input to the gate driver 521 is L level, the gate driver 521 outputs, as the voltage Vhdr, the voltage Vsw which is the low-potential-side power supply voltage. Here, the gate driver 521 is an example of a first driver circuit, the voltage Vbst corresponding to the power supply voltage of the gate driver 521 is an example of a first voltage, the voltage Vhdr corresponding to the first amplification control signal is an example of a first control signal, and the node N1 to which the voltage Vbst is supplied is an example of a first node.

The gate driver 522 electrically couples the node N7 to which the voltage Vlgd that is obtained by stepping down the voltage Vm by the diode D2 is supplied and the node N6 to which the voltage Vgnd is supplied, and generates the voltage Vldr based on the voltage Vlgd, the voltage Vgnd, and the modulation signal Ms to output the generated voltage Vldr to the node N5. Then, the voltage Vldr is supplied to the gate of the transistor M2 included in the switching circuit 550 via the node N5. In other words, the gate driver 522 outputs the voltage Vldr to the gate of the transistor M2 included in the switching circuit 550.

Specifically, a signal obtained by inverting the logic level of the modulation signal Ms by the inverter 515 is input to the gate driver 522. When the inverted modulation signal Ms input to the gate driver 522 is at H level, that is, when the modulation signal Ms output from the modulation circuit 510 is at L level, the gate driver 522 outputs, as the voltage Vldr, the voltage Vlgd which is the high-potential-side power supply voltage, and when the inverted modulation signal Ms input to the gate driver 522 is at L level, that is, when the modulation signal Ms output from the modulation circuit 510 is at H level, the gate driver 522 outputs, as the voltage Vldr, the voltage Vgnd which is the low-potential-side power supply voltage. Here, the gate driver 522 is an example of a second driver circuit, the voltage Vlgd corresponding to the power supply voltage of the gate driver 522 is an example of a second voltage, the voltage Vldr corresponding to the second amplification control signal is an example of a second control signal, and the node N7 to which the voltage Vlgd is supplied is an example of a second node.

The switching circuit 550 includes the transistors M1 and M2. The voltage VHV is supplied to the drain of the transistor M1. The source of the transistor M1 is electrically coupled to the node N3, and the voltage Vhdr is input to the gate of the transistor M1. On the other hand, the drain of the transistor M2 is electrically coupled to the node N3, the source of the transistor M2 is electrically coupled to the node N6, the voltage Vldr is input to the gate of the transistor M2. The transistors M1 and M2 operate based on the voltages Vhdr and Vldr, so that the voltage Vsw corresponding to the amplified modulation signal is output to the node N3. In other words, the transistor M1 is electrically coupled to the node N3 corresponding to the output point where the amplified modulation signal is output, and operates based on the voltage Vhdr, and the transistor M2 is electrically coupled to the node N3 corresponding to the output point where the amplified modulation signal is output, and operates based on the voltage Vldr.

Specifically, when the H-level voltage Vhdr is input to the gate of the transistor M1, control is performed so as to be in a conductive state between the drain and the source of the transistor M1, and when the L-level voltage Vhdr is input to the gate of the transistor M1, control is performed so as to be in a non-conductive state between the drain and the source of the transistor M1. That is, the transistor M1 outputs the voltage VHV supplied to the drain as the voltage Vsw in a period during which the H-level voltage Vhdr is supplied. On the other hand, when the H-level voltage Vldr is input to the gate of the transistor M2, control is performed so as to be in a conductive state between the drain and the source of the transistor M2, when the L-level voltage Vldr is input to the gate of the transistor M2, control is performed so as to be in a non-conductive state between the drain and the source of the transistor M2. That is, the transistor M2 outputs the signal of the ground potential as the voltage Vsw in a period during which the H-level voltage Vhdr is supplied.

Here, the transistor M1 is an example of a first transistor, the transistor M2 is an example of a second transistor, and the node N3 is an example of a coupling point.

One end of the capacitor C5 is electrically coupled to the node N1 to which the voltage Vbst is supplied, and the other end of the capacitor C5 is electrically coupled to the node N3 to which the voltage Vsw corresponding to the amplified modulation signal is supplied. The anode of the diode D1 is electrically coupled to the node N4 to which the voltage Vm having a voltage value different from that of both the voltages Vbst and Vlgd is supplied, and the cathode of the diode D1 is electrically coupled to the node N1 to which the voltage Vbst is supplied. That is, the capacitor C5 and the diode D1 functions as a bootstrap circuit that boosts the voltage value of the node N1 from the voltage Vsw by the voltage Vm with the potential of the node N3 to which the voltage Vsw which is an amplified modulation signal is supplied as the reference potential. In other words, the voltage value of the voltage Vbst supplied to the node N1 is higher than the voltage value of the voltage Vsw supplied to the node N3 by the voltage Vm by the bootstrap circuit composed of the capacitor C5 and the diode D1. As a result, the gate driver 521 that outputs the voltage Vbst as the voltage Vhdr can control the transistor M1 provided on the high side. Here, the capacitor C5 is an example of a capacitor, and the diode D1 is an example of a first diode. The voltage Vm is an example of a third voltage, and the node N4 to which the voltage Vm is supplied is an example of a power supply node.

The anode of the diode D2 is electrically coupled to the node N4 and the cathode is electrically coupled to the node N7. That is, the diode D2 steps down the voltage Vm supplied to the node N4 by the forward voltage of the diode D2, and supplies, as the voltage Vlgd, the stepped-down voltage Vm to the gate driver 522. Here, the diode D2 is only required to be able to step down the voltage Vm by a predetermined voltage value. That is, instead of the diode D2, various step-down circuits may be used. That is, the diode D2 is an example of the step-down circuit and a second diode, the anode of the diode D2 corresponds to one end of the step-down circuit, and the cathode of the diode D2 corresponds to the other end of the step-down circuit.

Next, the operation of the drive signal output circuit 51a configured as described above will be described based on the respective voltage values of the nodes N1 to N7. In the following description, the forward voltage of the diode D1 is referred to as a voltage Vf1 and the forward voltage of the diode D2 is referred to as a voltage Vf2.

First, the operation of the amplifier circuit 580 when the modulation signal Ms output from the modulation circuit 510 is at L level will be described. When the modulation signal Ms output from the modulation circuit 510 is at L level, the gate driver 521 outputs, as the voltage Vhdr, the voltage Vsw supplied to the node N3 to the node N2. As a result, the voltage Vhdr having the same potential as the voltage Vsw is supplied to the gate of the transistor M1. Here, the source of the transistor M1 is electrically coupled to the node N3. Therefore, when the modulation signal Ms is at L level, control is performed so as to be in a non-conductive state between the drain and the source of the transistor M1.

On the other hand, when the modulation signal Ms is at L level, the H level signal obtained by inverting the logic level of the modulation signal Ms by the inverter 515 is input to the gate driver 521. Therefore, the gate driver 521 outputs the voltage Vlgd supplied to the node N7 as the voltage Vldr to the node N5. As a result, the voltage Vldr having the same potential as the voltage Vlgd is supplied to the gate of the transistor M2. Here, the source of the transistor M2 is electrically coupled to the node N6 to which the voltage Vgnd which is the ground potential is supplied. Therefore, when the modulation signal Ms is at L level, control is performed so as to be in a conductive state between the drain and the source of the transistor M2.

As described above, when the modulation signal Ms is at L level, control is performed so as to be in a non-conductive state between the drain and the source of the transistor M1, and control is performed so as to be in a conductive state between the drain and the source of the transistor M2. As a result, the voltage value of the node N3 is controlled to be the voltage Vgnd which is the ground potential. Here, the voltage value of the voltage Vlgd when control is performed so as to be in a conductive state between the drain and the source of the transistor M2 is a value obtained by subtracting the voltage Vf2 that is the forward voltage of the diode D2 from the voltage Vm. That is, when the modulation signal Ms is at L level, and control is performed so as to be in a conductive state between the drain and the source of the transistor M2, the voltage Vldr supplied to the gate of the transistor M2 can be expressed by Expression (1).

Vldr=Vlgd=Vm−Vf2 (1)

In this case, the source of the transistor M2 is supplied with the voltage Vgnd that is the ground potential. Therefore, when the modulation signal Ms is at L level, and control is performed so as to be in a conductive state between the drain and the source of the transistor M2, the potential difference ΔVldr between the gate and the source of the transistor M2 can be expressed by Expression (2).

ΔVldr=Vm−Vf2 (2)

Next, the operation of the amplifier circuit 580 when the modulation signal Ms output from the modulation circuit 510 is at H level will be described. When the modulation signal Ms is at H level, the gate driver 521 outputs, as the voltage Vhdr, the voltage Vbst supplied to the node N1 to the node N2. Here, as described above, the voltage value of the voltage Vbst is higher than the voltage Vsw supplied to the node N3 by the voltage Vm. Therefore, when the modulation signal Ms is at H level, control is performed so as to be in a conductive state between the drain and the source of the transistor M1.

On the other hand, when the modulation signal Ms is at H level, the gate driver 522 outputs, as the voltage Vldr, the voltage Vgnd supplied to the node N6 to the node N5. As a result, the voltage Vldr having the same potential as the voltage Vgnd is supplied to the gate of the transistor M2. Here, the source of the transistor M2 is electrically coupled to the node N6. Therefore, when the modulation signal Ms is at L level, control is performed so as to be in a non-conductive state between the drain and the source of the transistor M2.

As described above, when the modulation signal Ms is at H level, control is performed so as to be in a conductive state between the drain and the source of the transistor M1, and control is performed so as to be in a non-conductive state between the drain and the source of the transistor M2. As a result, the voltage value of the node N3 is controlled to be the voltage VHV. Here, the voltage value of the voltage Vhdr when control is performed so as to be in a conductive state between the drain and the source of the transistor M1 is a value obtained by adding the voltage value of the voltage Vsw supplied to the node N3 to a value obtained by subtracting the voltage Vf1 which is the forward voltage of the diode D1 from the voltage Vm. That is, when the modulation signal Ms is at H level, and control is performed so as to be in a conductive state between the drain and the source of the transistor M1, the voltage Vhdr supplied to the gate of the transistor M1 can be expressed by Expression (3).

Vhdr=(Vm−Vf1)+Vsw (3)

In this case, the voltage Vsw is supplied to the source of the transistor M1. Therefore, when the modulation signal Ms is at H level, and control is performed so as to be in a conductive state between the drain and the source of the transistor M1, the potential difference ΔVhdr between the gate and the source of the transistor M1 can be expressed by Expression (4).

ΔVhdr=Vm−Vf1 (4)

Here, the driving capability of the transistor M1 included in the switching circuit 550 is determined by the potential difference between the gate and the source of the transistor M1, and the driving capability of the transistor M2 is determined by the potential difference between the gate and source of the transistor M2. The driving capability of the transistors M1 and M2 is the amount of current that can flow between the gate and the source of each of the transistors M1 and M2, in other words, it corresponds to the impedance between the gate and the source of each of the transistors M1 and M2 when control is performed so as to be in a conductive state between the gate and the source of each of the transistors M1 and M2.

When a difference occurs between the driving capability of the transistor M1 and the driving capability of the transistor M2 that constitute the switching circuit 550, there is the possibility that unintentional waveform distortion may occur in the amplified modulation signal generated at the node N3 which is the coupling point between the transistor M1 and the transistor M2. When such unintentional waveform distortion occurs in the amplified modulation signal, unintentional waveform distortion occurs in the drive signal COMA output from the drive signal output circuit 51a, and as a result, the ejection accuracy of the ink ejected from the print head 20 deteriorates.

For such a problem, the drive signal output circuit 51a in this embodiment includes the diodes D1 and D2, and reduces the possibility that a difference between the driving capability of the transistor M1 and the driving capability of the transistor M2 occurs by adjusting the voltage Vf1 which is the forward voltage of the diode D1, and the voltage Vf2 which is the forward voltage of the diode D2.

Specifically, the driving capability of the transistor M1 is defined by the voltage Vm and the voltage Vf1 which is the forward voltage of the diode D1, as represented in Expression (4). On the other hand, the driving capability of the transistor M2 is defined by the voltage Vm and the voltage Vf2 which is the forward voltage of the diode D2, as represented in Expression (2). That is, the drive signal output circuit 51a in this embodiment makes it possible to set a potential difference between the gate and the source of the transistor M1 and a potential difference between the gate and the source of the transistor M2 to have the same value by adjusting the voltage Vf1 which is the forward voltage of the diode D1, and the voltage Vf2 which is the forward voltage of the diode D2 to have the same value. As a result, the possibility that a difference between the driving capability of the transistor M1 and the driving capability of the transistor M2 occurs is reduced, and as a result, the possibility that unintentional waveform distortion may occur in the amplified modulation signal generated at the coupling point where the transistor M1 and the transistor M2 are electrically coupled is reduced. Therefore, the possibility that unintentional waveform distortion occurs in the drive signal COMA output from the drive signal output circuit 51a is reduced, and as a result, the possibility that the ejection accuracy of the ink ejected from the print head 20 deteriorates is reduced.

Here, the voltage Vf1 which is the forward voltage of the diode D1, and the voltage Vf2 which is the forward voltage of the diode D2 are preferably substantially equal. Here, “substantially equal” is not limited to “having the exact same value”, but may be “having a similar value in consideration of variations in characteristics and tolerance”. For example, it is sufficient that at least part of the range of the characteristic variation of the voltage Vf1 which is the forward voltage of the diode D1, and at least part of the range of the characteristic variation of the voltage Vf2 which is the forward voltage of the diode D2 overlaps each other in consideration of the environment such as temperature.

As a result, it is possible to further reduce the possibility that unintentional waveform distortion occurs in the amplified modulation signal generated at the coupling point where the transistor M1 and the transistor M2 are electrically coupled, and the possibility that unintentional waveform distortion occurs in the drive signal COMA output from the drive signal output circuit 51a is further reduced. As a result, it is possible to further reduce the possibility that the ejection accuracy of the ink ejected from the print head 20 deteriorates.

The capacitor C5 included in the bootstrap circuit that generates the voltage Vbst input to the gate driver 521 is preferably provided near the gate driver 521, specifically, near the terminal Bst of the integrated circuit 500 including the gate driver 521. In other words, the shortest distance between the gate driver 521 and the capacitor C5 is preferably shorter than the shortest distance between the gate driver 521 and the diode D1. As a result, the possibility that the potential of the voltage Vbst generated by the bootstrap circuit including the capacitor C5 changes due to the impedance of the propagation path through which the voltage Vbst propagates is reduced. Therefore, the possibility that the driving capability of the transistor M1 may vary is further reduced, and the possibility that unintentional waveform distortion may occur in the amplified modulation signal generated at the coupling point where the transistor M1 and the transistor M2 are electrically coupled is further reduced. Therefore, the possibility that unintentional waveform distortion occurs in the drive signal COMA output from the drive signal output circuit 51a is further reduced, and as a result, it is possible to further reduce the possibility that the ejection accuracy of the ink ejected from the print head 20 deteriorates.

### 1.7 Functions and Effects

As described above, in the liquid ejecting apparatus 1 according to the present embodiment, the amplifier circuit 580 included in the drive circuit 50 includes the gate driver 521 electrically coupled to the node N1 to which the voltage Vbst is supplied, where the gate driver 521 outputs the voltage Vhdr based on the voltage Vbst and the modulation signal Ms, the gate driver 522 electrically coupled to the node N7 to which the voltage Vlgd is supplied, where the gate driver 522 outputs the voltage Vldr based on the voltage Vlgd and the modulation signal Ms, the transistor M1 electrically coupled to the node N3 that outputs the voltage Vsw, where the transistor M1 operates based on the voltage Vhdr, the transistor M2 electrically coupled to the node N3 that outputs the voltage Vsw, where the transistor M2 operates based on the voltage Vldr, the node N4 to which the voltage Vgvd having a voltage value different from a voltage value of the voltage Vbst and a voltage value of the voltage Vlgd is supplied, the capacitor C5 whose one end is electrically coupled to the node N3 and whose other end is electrically coupled to the node N1, the diode D1 whose anode is electrically coupled to the node N4 and whose cathode is electrically coupled to the node N1, and the diode D2 that functions as a step-down circuit whose anode which is one end is electrically coupled to the node N4 and whose cathode which is the other end is electrically coupled to the node N7.

In the amplifier circuit 580 configured as described above, the voltage supplied to the gate of the transistor M1 is defined by the voltage Vgvd supplied to the node N3 and the voltage Vf1 that is the forward voltage of the diode D1, and the voltage supplied to the gate of the transistor M2 is defined by the voltage Vgvd supplied to the node N3 and the voltage Vf2 that is the forward voltage of the diode D2. Therefore, it is possible to adjust the driving capability of the transistor M1 and the transistor M2 included in the amplifier circuit 580 by adjusting the voltage Vf1 which is the forward voltage of the diode D1 and the voltage Vf2 which is the forward voltage of the diode D2. That is, it is possible to reduce variations in driving capability of the transistor M1 and the transistor M2 included in the amplifier circuit 580 by adjusting the voltage Vf1 which is the forward voltage of the diode D1 and the voltage Vf2 which is the forward voltage of the diode D2. Therefore, the possibility that the accuracy of the drive signal COMA output from the drive circuit 50 deteriorates is reduced, and as a result, the possibility that the ejection accuracy of the ink ejected from the liquid ejecting apparatus 1 deteriorates is reduced.

### 2. Second Embodiment

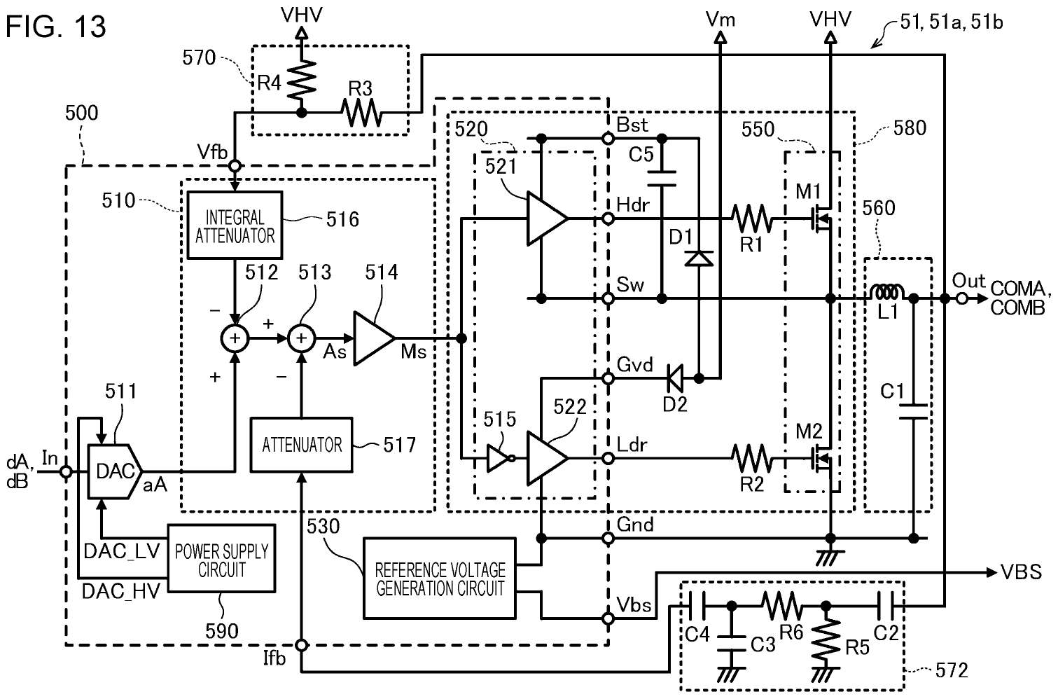

Next, the liquid ejecting apparatus 1 and the drive circuit 50 in the second embodiment will be described. FIG. 13 is a diagram illustrating the configuration of the drive signal output circuit 51a in the second embodiment. As in the liquid ejecting apparatus 1 and the drive circuit 50 according to the first embodiment, since the drive signal output circuit 51a and the drive signal output circuit 51b have the same configuration except that the input signal and the output signal are different, in the liquid ejecting apparatus 1 and the drive circuit 50 according to the second embodiment, only the configuration and operation of the drive signal output circuit 51a will be described, and the description of the configuration and operation of the drive signal output circuit 51b is omitted. As illustrated in FIG. 13, the drive circuit 50 in the second embodiment is different from the liquid ejecting apparatus 1 and the drive circuit 50 in the first embodiment in that the voltage Vm is generated outside the integrated circuit 500 included in the drive signal output circuit 51a.

In the drive signal output circuit 51a according to the first embodiment, since the voltage Vm is generated inside the integrated circuit 500, the voltage value of the voltage Vm is defined by the withstand voltage of the terminal Gvd of the integrated circuit 500. For this reason, even when the voltage value of the voltage Vm is set to the upper limit value of the withstand voltage of the terminal Gvd of the integrated circuit 500, the voltage value of the voltage Vbst supplied to the terminal Bst of the integrated circuit 500 is a value lower than the voltage value of the voltage Vm by the voltage Vf1 which is the forward voltage of the diode D1 as represented in the above Expression (1). That is, the voltage value of the voltage Vbst may be lower than the withstand voltage of the terminal Bst of the integrated circuit 500.

On the other hand, in the drive circuit 50 according to the second embodiment, since the voltage Vm is generated outside the integrated circuit 500 included in the drive signal output circuit 51a, the voltage value of the voltage Vm is not limited by the withstand voltage value of the terminal Gvd included in the integrated circuit 500. In other words, the voltage value of the voltage Vbst is defined by the withstand voltage of the terminal Bst of the integrated circuit 500. As a result, it is possible to increase the voltage value of the voltage Vhdr supplied to the gate of the transistor M1, and it is possible to improve the driving capability of the transistor M1.

Therefore, the amplifier circuit 580 can output more current, and as a result, it is possible to drive more piezoelectric elements 60 by the drive signal COMA output from the drive signal output circuit 51a. As a result, the print head 20 can have more nozzles 651, so that it is possible to achieve the high-resolution of the image formed by the ink ejected from the print head 20 and to improve the ink ejection speed of the liquid ejecting apparatus 1.

That is, in addition to the functions and effects of the liquid ejecting apparatus 1 and the drive circuit 50 according to the first embodiment, the liquid ejecting apparatus 1 and the drive circuit 50 according to the second embodiment make it possible to achieve the high-resolution of an image formed by the liquid ejecting apparatus 1 and to further improve the printing speed.

Although the embodiments have been described above, the present disclosure is not limited to the embodiments, and can be implemented in various modes without departing from the gist of the disclosure. For example, the respective embodiments can be combined appropriately.

The disclosure includes a configuration substantially same as the configuration described in the embodiments (for example, a configuration having the same function, method, and result, or a configuration having the same object and effect). Further, the disclosure includes a configuration in which a non-essential part of the configuration described in the embodiments is replaced. Further, the disclosure includes a configuration having the same functions and effects as the configuration described in the embodiments or a configuration capable of achieving the same object. The disclosure also includes a configuration in which a known technique is added to the configuration described in the embodiments.

What is claimed is:

1. A liquid ejecting apparatus comprising:
an ejection head having a drive element, the drive element driving by being supplied with a drive signal, the ejection head ejecting a liquid by driving of the drive element; and
a drive circuit that outputs the drive signal, wherein
the drive circuit includes
a modulation circuit that modulates a base drive signal that serves as a base of the drive signal and outputs a modulation signal,
an amplifier circuit that amplifies the modulation signal and outputs an amplified modulation signal, and
a demodulation circuit that demodulates the amplified modulation signal and outputs the drive signal, and
the amplifier circuit includes
a first driver circuit electrically coupled to a first node to which a first voltage is supplied, the first driver circuit outputting a first control signal based on the first voltage and the modulation signal,
a second driver circuit electrically coupled to a second node to which a second voltage is supplied, the second driver circuit outputting a second control signal based on the second voltage and the modulation signal,
a first transistor electrically coupled to an output point from which the amplified modulation signal is output, the first transistor operating based on the first control signal,
a second transistor electrically coupled to the output point, the second transistor operating based on the second control signal,
a power supply node to which a third voltage having a voltage value different from a voltage value of the first voltage and a voltage value of the second voltage is supplied,
a capacitor whose one end is electrically coupled to the output point and whose other end is electrically coupled to the first node,
a first diode whose anode is electrically coupled to the power supply node and whose cathode is electrically coupled to the first node, and
a step-down circuit whose one end is electrically coupled to the power supply node and whose other end is electrically coupled to the second node.

2. The liquid ejecting apparatus according to claim 1, wherein
the step-down circuit includes a second diode whose anode is electrically coupled to the power supply node and whose cathode is electrically coupled to the second node.

3. The liquid ejecting apparatus according to claim 2, wherein
a forward voltage of the first diode is substantially equal to a forward voltage of the second diode.

4. The liquid ejecting apparatus according to claim 1, wherein
a shortest distance between the first driver circuit and the capacitor is shorter than a shortest distance between the first driver circuit and the first diode.

5. A drive circuit that outputs a drive signal that drives a drive element, the drive circuit comprising:
a modulation circuit that modulates a base drive signal that serves as a base of the drive signal and outputs a modulation signal;
an amplifier circuit that amplifies the modulation signal and outputs an amplified modulation signal; and
a demodulation circuit that demodulates the amplified modulation signal and outputs the drive signal, wherein
the amplifier circuit includes
a first driver circuit electrically coupled to a first node to which a first voltage is supplied, the first driver circuit outputting a first control signal based on the first voltage and the modulation signal,
a second driver circuit electrically coupled to a second node to which a second voltage is supplied, the second driver circuit outputting a second control signal based on the second voltage and the modulation signal,
a first transistor electrically coupled to an output point from which the amplified modulation signal is output, the first transistor operating based on the first control signal,
a second transistor electrically coupled to the output point, the second transistor operating based on the second control signal,
a power supply node to which a third voltage having a voltage value different from a voltage value of the first voltage and a voltage value of the second voltage is supplied,
a capacitor whose one end is electrically coupled to the output point and whose other end is electrically coupled to the first node,
a first diode whose anode is electrically coupled to the power supply node and whose cathode is electrically coupled to the first node, and
a step-down circuit whose one end is electrically coupled to the power supply node and whose other end is electrically coupled to the second node.
